(19) United States
(12) Patent Application Publication
(10) Pub. No.: US 2003/0023525 A1
(43) Pub. Date: Jan. 30, 2003

(54) Real time valuation of option-embedded coupon bearing bonds by option adjusted spread and linear approximation

(76) Inventor: Hua Chen, Brooklyn, NY (US)

Correspondence Address: Kevin R. Erdman, Suite 2700, 300 North Meridian Street, Indianapolis, IN, 46204, US

(21) Appl. No.: 09/880,309

(22) Filed: Jun. 13, 2001

(51) Int. Cl. G06F 17/60

(52) U.S. Cl. 705/35

(57) ABSTRACT

The present invention involves a method and an apparatus capable of calculating, in real time, option-embedded coupon bearing bonds by option adjusted spread and linear approximation. The linear approximation uses a first order partial derivative to calculate a vector of sensitivities of bond price against yield curve by which an nth order linear approximation of the bond price can be approximated. The apparatus comprises a plurality of trader's workstations, one of which may serve as an option adjusted spread lattice engine for full lattice computation. The trader's workstations may be actuated by a triggering object, which receives yield curve, bond price, spread, volatility and other bond information updates from a database server. For each security, the Lattice Engine uses the lattice method to compute the price of the security and a vector of partial derivatives of the security price with respect to the yield curve. While other workstations, upon receiving any update of the yield curve, use the results of the Lattice Engine to perform first order approximation of the security prices. Since linear approximation is a simple calculation, the price update of a large number of securities can be carried out in real time. Because the Lattice Engine recalculates the first order partial derivatives when the yield curve has changed significantly, the linear approximations are very accurate in general.

### COPYRIGHT

A portion of the disclosure of this patent document contains material which is the subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

1. Field of the Invention

The present invention relates generally to systems and methods for the calculation of valuation for option-embedded coupon bearing bonds.

2. Background Art

Coupon bearing bonds are bonds with coupons. “Coupon” is generally defined as the interest rate on a fixed income security, determined upon issuance, and expressed as a percentage of par. A “par value” of a bond is the amount that the bond pays at maturity in excess of the final coupon payment. For a bond that is issued at par, coupons represent interest payments and the par value is the bond's principal. “Option-embedded coupon bearing bonds” are bonds that have options-embedded. For instance, there are two most common options—the call and the put-options.

A “call option” is the first type of common embedded option, which gives the buyer the right but not the obligation to purchase the bond at a given price. For example, an institution issues bonds with a maturity of twenty years. It also provides a call-option on the bonds at the end of ten years, hence the name “callable bonds.” This means the institution reserves the right to buy back these bonds from the investors at the end of ten years. But it only has the right to, and need not necessarily, exercise the options. A “put option” is the other common embedded option, which is the opposite of a call-option. When the issuer of a bond attaches a put-option, it means that an investor who has purchased the bond has the right, but not the obligation, to sell the bond back to the issuing institution, at a predetermined price.

Generally, the Option Adjusted Spread (henceforth referred to as OAS) is used as a means of representing the yield on bonds with embedded option features, such as callable bonds as mentioned above. OAS enables the investor to compare the yield on callable bonds with the yield on comparable vanilla bonds, where vanilla bonds are bonds with predetermined coupon payment. The vanilla bonds are also referred to as “bullet” bonds. A “yield” is generally a measure of a bond's potential return. The value of OAS is that it enables investors to directly compare fixed income instruments, which have similar characteristics, but trade at significantly different yields because of imbedded options. Therefore, Option-adjusted spreads are used for analyzing a variety of instruments, including callable bonds, structured notes and mortgage-backed securities. They can also be applied to entire portfolios of instruments. Therefore, the important role OAS plays in bond valuation is obvious.

One of most commonly used method for security pricing is the benchmarking method. In this method, the price of a security (we call this security the “dependent security”) is derived from the known price of another security (which we call the “independent security”). The OAS method is a natural extension of this benchmark relationship. In the OAS method, the independent security is replace by a benchmark “yield curve”. A yield curve a set of yield/maturity pairs computed from the values of a set of very liquid securities in the market.

Given the benchmark yield curve, we can compute the price of the security by discounting to the present the values of the coupon and principal payment of the bond (these payments are called cashflows) by the rates obtained from the yield curve. However, this price is usually incorrect because the benchmark securities used in the yield curve will have different (usually higher) credit ratings and liquidity compare to the dependent security. Indeed, the common practice is to use the benchmark rates plus a spread to discount the cashflows of the dependent security. Moreover, often the “inverse” problem is encountered when we are trying to find the right “spread” value which when applied for discounting the cashflows, the sum of the present values of all cashflows matches the known price of the security. If the security has embedded options, the option feature will increase or decrease this “spread” depending on whether the it is call or put option, therefore the “spread” is referred to as the “Option Adjusted Spread”.

Given the benchmark yield curve, the relationship among the price of the dependent security, the OAS and the yield curve volatility is determined by a second order partial differential equation. This equation is a variation of the well-known Black-Scholes equation for option pricing. Here “volatility” is a statistical measure of the tendency of a market indicator to vary over time. As in most cases this type of equations can't be solved exactly. Instead, numerical methods are used to obtain solution that can be as close to the exact solution as desired given sufficient computational resources. The most common numerical method is the “lattice method”. In this method, a discrete grid of possible values of the solution is used to derive a solution. The density of grid points determines the accuracy of the solution. To get more accurate solution we need more grid points and therefore more computational resource (CPU and memory.)

The yield curve, the dependent security price, the OAS and the volatility are all variables or parameters in the differential equation, a change in any one of them should trigger a re-evaluation of other variables and parameters. However, we make a reasonable assumption that the OAS and the volatility are relatively stable variables and therefore are not subject to nearly as frequent update as the yield curve and the security price. In addition, because the securities used in building the yield curve are usually the most liquid securities in the market, their prices are updated in real time, we assume the yield curve “drives” the prices of the dependent securities. For these reasons, we have focused on solving the problem calculating the prices of the dependent securities when the yield curve is updated.

In an actual trading environment, a trader may be monitoring hundreds or thousands of securities in a given market, the computational cost of updating them in real time is enormous. For instance, on a Pentium III processor, a lattice computation of the bond price and other associated risk parameters can take one to two seconds. Suppose a trader have 600 callable agency bonds priced via the OAS relations, then each update of the yield curve will trigger computation that last 10 to 20 minutes. Technically, this computation can be implemented in three ways:

1. The first is the “in-process” (or synchronous) implementation. In this case, the control of the application will not be returned to the user until the computation is finished. This could mean that the user might never have any control over the application since other updates of the yield curve may have already queued up for the application to process. Therefore this approach is clearly unacceptable.

2. The second is the “out-of-process” (asynchronous) implementation. In this case, the control is immediately returned to the process for the user interface, and a separate process is spawn to carry out the lattice computation. When the calculation is finished, the user interface process is notified for displaying the updated results. While this approach does solve the control problem, it has an obvious drawback: the prices are out of date between updates (which is the majority of time.) Additionally, the system performance will be sluggish since the lattice computation will consume a large amount of computing resource.

3. The third approach is to carry out the asynchronous lattice computation on a separate computer. While this certainly improves the performance on user's workstation, the prices are still out of date between updates.

Clearly we need a very different approach. While there are several implementations of OAS systems from software venders, none of them addressed the issue discussed in the previous paragraphs. The purpose of current invention is to design and implement a system that can accurately update a large number of OAS prices in real time.

### SUMMARY OF THE INVENTION

The present invention involves a callable bond portfolio valuation system using a matrix of differential equation approximation variables to quickly calculate values based on small changes of the yield curve, and using a device to recalculate and update the matrix upon a significant change in the yield curve. This allows real-time update of OAS prices of a large number of securities based on the most current yield curve. For a network of traders, a shared book may be accessed and updated to provide near instantaneous updating of OAS prices across the network.

Currently, there are various implementations of the OAS system, none is in real time. The difficulty is the main difficulty in achieving the stated task is the fact that the price of the dependent security is a solution to a partial differential equation, and this solution can't be derived from an algebraic formula (such as the solution to a linear or quadratic equation) or a simple iterative algorithm (such as price to yield calculation). However, a solution of desired accuracy can be obtained using a numerical method such as the lattice method at a significant cost in computational resources.

The present invention takes advantage of the fact that relationship between small changes in the benchmark yield curve and the corresponding change in the bond price is almost a linear relation. Therefore, a linear formula can be used to approximate such a “locally linear” relationship. The parameters of this linear approximation formula are obtained from a full lattice computation that is performed on a separate workstation. The calculation for such linear approximation can be done in a fraction of time needed for the lattice calculation. The approximations are accurate provided the change in the yield curve is small. To ensure the accuracy of the approximations, when the accumulated change in the yield curve is sufficiently large, full lattice computations are used to reset the parameters of the linear approximation formula.

The present invention is implemented in a RAPTr-NT™ system, which is a front office platform that integrates the latest trading, computing, and communication technologies into a system that can reliably route, process, and control the massive data flows characteristic of E-trading. One of the main features of the RAPTr-NT™ system is the Workbench architecture where the casual relations, business logic and execution flows are implemented. One of the basic RAPTr-NT™ workbenches is a “book”. Here a book is a repository of securities from a particular market that a trader will likely to trade. The book also contains the prices of these securities and various relations between of these prices. Therefore when the price of any security in the book changes, it may trigger a cascading update of prices of other securities through the relation trees established in the book.

The present invention is implemented with an asynchronous dual architecture within the RAPTr NT system. In particular, the network may contain a plurality of trader's workstations that share the same book, one of which is designated as an OAS lattice engine. Under the workbench architecture, when the prices of securities in the benchmark yield curve have changed, each workstation will react to the change:

1. On the OAS Lattice Engine, for each security set up for OAS pricing, the total accumulative change in the yield curve since the last lattice calculation is measured, if the total change has crossed a threshold, and then a full lattice computation ensues. In such case, the Lattice Engine not only computes the price of each dependent security, it also compute the parameters that will be used by the trader's workstation to conduct linear approximation. We refer these parameters as the “sensitivity factors”, because they measure the sensitivities of the dependent price with respect to the changes in the values of securities in the yield curve. More precisely, the new price, the sensitivity factors and the current values of the yield curve are saved in a data object called OAS Delta Object in the database and published to all other workstations on the network. There is an OAS Delta object for each dependent security on the database. For each security, the threshold is set at a default height initially and decreases as time elapses. The OAS Lattice Engine resets the threshold to the default height after the OAS lattice computation of each security.

2. Upon any change in the yield curve, each trader's workstation will get the latest OAS Delta object and the latest yield curve from the database server. By measuring the changes from the yield curve values saved in the OAS Delta Object and applying them together with the sensitivities factors to the linear approximation formula, we get the updated price of the dependent security. This operation is done almost instantaneously, therefore allowing real time price update of a large number of securities.

Furthermore, the present invention implements the OAS Lattice Engine on a PC workstation, all other workstations sharing the Shared Book will use the results from the OAS Lattice Engine to update the bond prices by linear approximation (a “book” is a securities book entry represented in computer records rather than by traditional engraved certificates). Such structure allows OAS Lattice Engine be shutdown or restarted from any workstation.

An object of the invention is to provide fast and accurate calculation of OAS, thus making real time valuation of option-embedded coupon bearing bonds possible.

An another object of the invention is to create a system that is capable of providing a plurality of hundreds, or even thousands of valuations of option-embedded coupon bearing bonds in real time.

In the embodiment, for each given RAPTr NT book that requires OAS computation, there is one OAS Lattice Engine. All other workstations sharing the same book will use the results from the Lattice Engine. Changing any of the following five parameters will trigger OAS computation: price, volatility, spread, yield curve and manual trigger, where “volatility” is a statistical measure of the tendency of a market price or yield to vary over time and “spread” is the difference between the yields or prices of two financial instruments. In particular, the RAPTr NT system comprises a plurality of trader's workstations, one of which is designated as an option adjusted spread lattice engine for full lattice computation. The trader's workstations are controlled by a sensitivity object detector, which receives yield curve, bond price, spread, volatility and other bond information updates from a database server. The sensitivity object detector also receives sensitivity object from the lattice engine after each full lattice computation. By such structure, the trader's workstations can, asynchronously and in real time, update bond price using linear approximation upon any change in bond price, yield curve, spread, volatility, manual trigger or sensitivity object from a full lattice computation when triggered by a predetermined threshold of an accumulated change in yield curve. Such structure and linear approximation method can also be used for the real time calculation of risk parameters, such as Val01, modified duration and Vega. When the linear approximation is replaced by a second order non-linear approximation, risk parameter convexity can also be calculated in real time.

### BRIEF DESCRIPTION OF THE DRAWINGS

The above mentioned and other features and objects of this invention, and the manner of attaining them, will become more apparent and the invention itself will be better understood by reference to the following description of embodiment of the invention taken in conjunction with the accompanying drawings, wherein:

FIG. 1 is a flowchart of an exemplary embodiment of the invention in RAPTr NT system.

FIGS. 2(a) and 2(b) are RAPTr NT Lattice Computation and Linear Approximation Comparison Grid, respectively.

Corresponding reference characters indicate corresponding parts throughout the view. Although the drawings represents one embodiment of the present invention, the drawings are not necessarily to detail and certain features may be exaggerated in order to better illustrate and explain the present invention. The exemplification set out herein illustrates one embodiment of the invention, and such exemplification is not to be construed as limiting the scope of the invention in any manner.

### DESCRIPTION OF THE EXEMPLARY EMBODIMENT

The embodiment disclosed below is not intended to be exhaustive or limit the invention to the precise forms disclosed in the following detailed description. Rather, the embodiment is chosen and described so that others skilled in the art may utilize its teachings.

The detailed descriptions that follow are presented in part in terms of algorithms and symbolic representations of operations on data bits within a computer memory representing alphanumeric characters or other information. These descriptions and representations are the means used by those skilled in the art of data processing arts to most effectively convey the substance of their work to others skilled in the art.

An algorithm is here, and generally, conceived to be a self-consistent sequence of steps leading to a desired result. These steps are those requiring physical manipulations of physical quantities. Usually, though not necessarily, these quantities take the form of electrical or magnetic signals capable of being stored, transferred, combined, compared, and otherwise manipulated. It proves convenient at times, principally for reasons of common usage, to refer to these signals as bits, values, symbols, characters, display data, terms, numbers, or the like. It should be borne in mind, however, that all of these and similar terms are to be associated with the appropriate physical quantities and are merely used here as convenient labels applied to these quantities.

Some algorithms may use data structures for both inputting information and producing the desired result. Data structures greatly facilitate data management by data processing systems, and are not accessible except through sophisticated software systems. Data structures are not the information content of a memory, rather they represent specific electronic structural elements which impart a physical organization on the information stored in memory. More than mere abstraction, the data structures are specific electrical or magnetic structural elements in memory which simultaneously represent complex data accurately and provide increased efficiency in computer operation.

Further, the manipulations performed are often referred to in terms, such as comparing or adding, commonly associated with mental operations performed by a human operator. No such capability of a human operator is necessary, or desirable in most cases, in any of the operations described herein which form part of the present invention; the operations are machine operations. Useful machines for performing the operations of the present invention include general purpose digital computers or other similar devices. In all cases the distinction between the method operations in operating a computer and the method of computation itself should be recognized. The present invention relates to a method and apparatus for operating a computer in processing electrical or other (e.g., mechanical, chemical) physical signals to generate other desired physical signals.

The present invention also relates to an apparatus for performing these operations. This apparatus may be specifically constructed for the required purposes or it may comprise a general purpose computer as selectively activated or reconfigured by a computer program stored in the computer. The algorithms presented herein are not inherently related to any particular computer or other apparatus. In particular, various general purpose machines may be used with programs written in accordance with the teachings herein, or it may prove more convenient to construct more specialized apparatus to perform the required method steps. The required structure for a variety of these machines will appear from the description below.

The present invention deals with “object-oriented” software. The “object-oriented” software is organized into “objects”, each comprising a block of computer instructions describing various procedures (“methods”) to be performed in response to “messages” sent to the object or “events” which occur with the object. Such operations include, for example, the manipulation of variables, the activation of an object by an external event, and the transmission of one or more messages to other objects.

Messages are sent and received between objects having certain functions and knowledge to carry out processes. Messages are generated in response to user instructions, for example, by a user activating an icon with a “mouse” pointer generating an event. Also, messages may be generated by an object in response to the receipt of a message. Further, external stimuli, such as an ECN trade, may cause an object to generate an event. When one of the objects receives a message, the object carries out an operation (a message procedure) corresponding to the message and, if necessary, returns a result of the operation. Each object has a region where internal states (instance variables) of the object itself are stored and where the other objects are not allowed to access. One feature of the object-oriented system is inheritance. For example, an object for drawing a “circle” on a display may inherit functions and knowledge from another object for drawing a “shape” on a display.

A programmer “programs” in an object-oriented programming language by writing individual blocks of code each of which creates an object by defining its methods. A collection of such objects adapted to communicate with one another by means of messages comprises an object-oriented program. Object-oriented computer programming facilitates the modeling of interactive systems in that each component of the system can be modeled with an object, the behavior of each component being simulated by the methods of its corresponding object, and the interactions between components being simulated by messages transmitted between objects.

An operator may stimulate a collection of interrelated objects comprising an object-oriented program by sending a message to one of the objects. The receipt of the message may cause the object to respond by carrying out predetermined functions which may include sending additional messages to one or more other objects. The other objects may in turn carry out additional functions in response to the messages they receive, including sending still more messages. In this manner, sequences of message and response may continue indefinitely or may come to an end when all messages have been responded to and no new messages are being sent. When modeling systems utilizing an object-oriented language, a programmer need only think in terms of how each component of a modeled system responds to a stimulus and not in terms of the sequence of operations to be performed in response to some stimulus. Such sequence of operations naturally flows out of the interactions between the objects in response to the stimulus and need not be preordained by the programmer.

Although object-oriented programming makes simulation of systems of interrelated components more intuitive, the operation of an object-oriented program is often difficult to understand because the sequence of operations carried out by an object-oriented program is usually not immediately apparent from a software listing as in the case for sequentially organized programs. Nor is it easy to determine how an object-oriented program works through observation of the readily apparent manifestations of its operation. Most of the operations carried out by a computer in response to a program are “invisible” to an observer since only a relatively few steps in a program typically produce an observable computer output.

In the following description, several terms which are used frequently have specialized meanings in the present context. The term “object” relates to a set of computer instructions and associated data which can be activated directly or indirectly by the user. The terms “windowing environment”, “running in windows”, and “object oriented operating system” are used to denote a computer user interface in which information is manipulated and displayed on a video display such as within bounded regions on a raster scanned video display. The terms “network”, “local area network”, “LAN”, “wide area network”, or “WAN” mean two or more computers which are connected in such a manner that messages may be transmitted between the computers. In such computer networks, typically one or more computers operate as a “server”, a computer with large storage devices such as hard disk drives and communication hardware to operate peripheral devices such as printers or modems. Other computers, termed “workstations”, provide a user interface so that users of computer networks can access the network resources, such as shared data files, common peripheral devices, and inter-workstation communication. Users activate computer programs or network resources to create “processes” which include both the general operation of the computer program along with specific operating characteristics determined by input variables and its environment.

The terms “desktop”, “personal desktop facility”, and “PDF” mean a specific user interface which presents a menu or display of objects with associated settings for the user associated with the desktop, personal desktop facility, or PDF. When the PDF accesses a network resource, which typically requires an application program to execute on the remote server, the PDF calls an Application Program Interface, or “API”, to allow the user to provide commands to the network resource and observe any output. The term “Browser” refers to a program which is not necessarily apparent to the user, but which is responsible for transmitting messages between the PDF and the network server and for displaying and interacting with the network user. Examples of Browsers compatible with the present invention include the Navigator program sold by Netscape Corporation and the Internet Explorer sold by Microsoft Corporation (Navigator and Internet Explorer are trademarks of their respective owners). Although the following description details such operations in terms of a graphic user interface of a Browser, the present invention may be practiced with text based interfaces, or even with voice or visually activated interfaces, that have many of the functions of a graphic based Browser.

The present invention also relates to an apparatus for performing these operations. This apparatus may be specifically constructed for the required purposes or it may comprise a general purpose computer as selectively activated or reconfigured by a computer program stored in the computer. The algorithms presented herein are not inherently related to any particular computer or other apparatus. In particular, various general purpose machines may be used with programs written in accordance with the teachings herein, or it may prove more convenient to construct more specialized apparatus to perform the required method steps. The required structure for a variety of these machines will appear from the description below. In particular, although the disclosed embodiment deals with Microsoft's ActiveX environment, the present invention is equal, applicable to other object oriented operating systems such as JAVA compatible or LINUX based systems. Similarly, although the present invention is described with a specific embodiment referencing Microsoft's Windows NT operating system, the invention is compatible with Microsoft's Windows 2000 operating system and is envisioned to be compatible with future operating systems.

The present invention is implemented in a RAPTr-NT™ system, which is a front office platform that integrates the latest trading, computing, and communication technologies into a system that can reliably route, process, and control the massive data flows characteristic of E-trading. The RAPTr-NT™ system is disclosed in copending U.S. Provisional patent application Ser. No. 09/614,521, filed on Jul. 11, 2000, entitled PERSISTENCE CONTROL AND COORDINATION FOR TRADING SYSTEM OBJECT ORIENTED SYSTEM AND METHOD, assigned to the assignee of the present invention, the disclosure of which is incorporated by reference herein. Although this disclosure of the invention is made in the context of the RAPTr-NT™ system, the principles of the invention may be implemented in a variety of systems supporting real time securities trading applications.

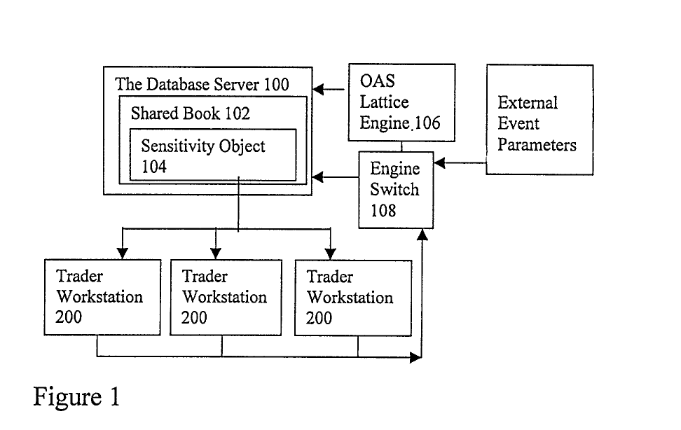

As can be seen with reference to FIG. 1 in greater detail, in one embodiment, Database Server 100 comprises Shared Book 102 which provides data to Sensitivity Object detector 104. Sensitivity Object detector 104 provides changes in price, yield curve, spread and volatility, or a manual trigger to a plurality of Trader Workstations 200 which then update bond price and four risk parameters, yield curve shift (denoted Val01), duration, convexity and Vega whenever any such change occurs. A predetermined threshold is used to measure accumulative yield curve changes. When such accumulated changes surpass the threshold, Engine Switch 108 triggers Option Adjusted Spread Lattice Engine 106 to do a full lattice computation. After such full lattice computation, Lattice Engine 106 updates vector of sensitivities to OAS Delta Object 104. The update in RAPTrNT is done either by a real time linear approximation when yield changes are small, or a regular lattice computation when yield changes are large. Such an asynchronous structure allows bond price updates on Trader's Workstations 200's always in real time.

Since both computer systems and bond calculation related parameters have many common features the essence of this invention may be practiced in many ways and configurations. A person skilled in this art can draw from the current conventional solutions in order to deal with the particular problems confronted.

In the description that follows, an equivalent element will be generally designated by an identical reference numeral in each distinct embodiment.

The OAS Method. Option Adjusted Spread is a method used in valuation of option-embedded coupon bearing bonds and mortgage instruments. It is a natural extension of the traditional benchmark spread method.

The regular benchmark spread relationship is a linear relationship where the dependent yield is the sum of benchmark yield and spread. The advantage of this method is the simplicity, given a new benchmark yield, the dependent yield can be computed instantaneously and the price can be obtained through a fast price-yield calculation. The disadvantage is that it explicitly accounts for only one source of the risk, namely the benchmark yield risk.

By replacing the independent instrument in a benchmark relationship with a yield curve, we can get the spread-off-yield-curve method. To calculate the price of the dependent instrument, the discount rate for each cashflow is defined to be:

discount rate for the cashflow=yield curve rate+spread

where the yield-curve-rate is obtained from the yield curve by interpolation. The spread is defined to be a constant value so that the bond price calculated from the discount rates as above will match its market price. In this case, the price is driven by the yield curve discount rates on all the cashflow time stamped dates.

For a bond with embedded options, the cashflows are no longer deterministic. In this case, we need to solve a differential equation for the price of the bond. Since most of these embedded options are American (continuously callable) or Bermudan (discretely callable on a sequence of dates) style options, these equations can only be solved by numerical methods such as binomial lattice, trinomial lattice or Monte Carlo simulation. In the case of the lattice method, the yield curve and the volatility of the yield curve are used to construct a lattice of discount rates. A constant basis spread will then be added to the discount rates at each node for the valuation on the lattice. This constant spread is called the Option Adjusted Spread, or OAS.

By making various assumptions on volatility of the model, we end up with different types of differential equations. The simplest and the most common assumption in the OAS analysis is that the volatility of the interest rate is constantly proportional to the magnitude of the interest rate. We call this model the lognormal model because the logarithm of the interest rate has a Gaussian Normal probability distribution. Since the volatility in percentage terms is constant, we often say that it has constant volatility. The advantage of this model is the simplicity of the input parameter; and the disadvantage is that the constant volatility assumption may not reflect the actual market condition. However, it is very common to assume a constant volatility for the purpose of OAS analysis in practice.

Existing OAS Systems and Their Limitations. Numerical methods for solving differential equations are computationally demanding. As stated above, on a Pentium III processor, a full lattice computation of the bond price, duration and convexity can take one second or more. In a trading environment where the benchmark yields can change in real time and hundreds or thousands of OAS prices need to be updated with these parameters, this computation cost is much too high to provide real time results.

Although for risk management systems the speed is not a crucial factor, traders require valuation of option-embedded coupon bearing bonds where high speed and real time calculation is highly desirable. Among the various implementations of the OAS system on the market, there is not a system that provides solution to this problem. On a Bloomberg Terminal, for example, OAS computation is done for one instrument at a time. Thus, while an individual callable bond may be computed, a portfolio of several bonds poses difficulties.

The RAPTr NT Approach. The real difficulty of calculating OAS is the fact that there is no algebraic formula, such as the benchmark relation, or a simple algorithm, such as price yield calculation, to derive the price of the bond from the yield curve. Fortunately, this is a well-understood problem in other scientific and engineering fields. We observe that the relationship between small changes in the yield curve and corresponding change in the bond price is almost a linear relationship, i.e.:

Y₁=The ith benchmark yield

Y=(Y₁,Y₂ . . . , Yₙ) The vector of benchmark yields

ΔY₁=Change in the ith benchmark yield

ΔY=(ΔY₁,ΔY₂, . . . , ΔYₙ) The vector of changes in benchmark yield

P(Y)=Price of a bond given the benchmark yield vector Y

ΔP=P(Y+ΔY)−P(Y) The change in price when benchmark yield vector changed from Y to Y+ΔY

$$\frac{\partial P}{\partial {Y}_{i}} = Price Sensitivity ( partial derivative ) to the ith Yield .$$

Price Sensitivity partial derivative) to the ith Yield. This relationship is a pseudo linear one.

$$\frac{\partial P}{\partial Y} = ( \frac{\partial P}{\partial {Y}_{1}} , \frac{\partial P}{\partial {Y}_{2}} , \frac{\partial P}{\partial {Y}_{3}} , … , \frac{\partial P}{\partial {Y}_{n}} )$$

The vector of sensitivities.

### The Linear Approximation Formulas:

$$\begin{matrix}Δ P \approx \frac{\partial P}{\partial {Y}_{1}} \cdot Δ {Y}_{1} + \frac{\partial P}{\partial {Y}_{2}} \cdot Δ {Y}_{2} + … + \frac{\partial P}{\partial {Y}_{n}} \cdot Δ {Y}_{n} or & ( 1 ) \\ P ( Y + Δ Y ) \approx P ( Y ) + \frac{\partial P}{\partial {Y}_{1}} \cdot Δ {Y}_{1} + \frac{\partial P}{\partial {Y}_{2}} \cdot Δ {Y}_{2} + … + \frac{\partial P}{\partial {Y}_{n}} \cdot Δ {Y}_{n} & ( 2 )\end{matrix}$$

where ∂P and ∂Yᵢ are all observable values.

The reason that we can replace a complicated relationship by a linear formula in a small area is due to the “locally linear” relationship. This mathematical property suggests a technological solution to the OAS problem: when changes in the yield curve is small, we approximate the price of the bond using the linear approximation formula 2, which can be done in real time; when these small changes have finally added up to a sufficiently large change, we do a regular full lattice computation.

On RAPTrNT, this solution is implemented with the asynchronous dual architecture as shown in FIG. 1.

On the OAS Lattice Engine 106, when the Engine Switch 108 switched on or when there is a sufficient change in the benchmark yield curve, it does a full lattice computation for each bond, and produces and publishes through the database the following OAS Delta Object 104:

### The OAS Delta Object 104

$$\frac{\partial P}{\partial Y} = ( \frac{\partial P}{\partial {Y}_{1}} , \frac{\partial P}{\partial {Y}_{2}} , \frac{\partial P}{\partial {Y}_{3}} , … , \frac{\partial P}{\partial {Y}_{n}} )$$

The vector of sensitivities.

Y⁰=(Y₁⁰,Y₂⁰, . . . , Yₙ⁰) The vector of benchmark yield at the time of computation.

P(Y⁰)=Bond Price

While on users' workstations, upon any change in the yield curve, the OAS Delta Object 104 is used to linearly approximate the bond price:

### Computation on User's Workstation

Y=(Y₁,Y₂, . . . , Yₙ) The current benchmark yield.

ΔY₁=Y₁−Y₁⁰ 3)

$$P ( Y ) \approx P ( {Y}^{0} ) + \frac{\partial P}{\partial {Y}_{1}} \cdot Δ {Y}_{1} + \frac{\partial P}{\partial {Y}_{2}} \cdot Δ {Y}_{2} + … + \frac{\partial P}{\partial {Y}_{n}} \cdot Δ {Y}_{n} \qquad ( 4 )$$

Since this is a simple computation that can be accomplished almost instantaneously, it is possible to update hundreds of the bond prices in a book in real time.

In addition to the price, other risk parameters are also computed by either linear or non-linear approximations:

### Risk Parameters

1. Val01:

P(y)=Price of the bond with the current Yield Curve.

P(y+Δy)=Price of the bond after upward parallel shift Δy of the current Yield Curve.

P(y−Δy)=Price of the bond after downward parallel shift Δy of the current Yield Curve. Therefore,

$$Val 01 = \frac{\partial P}{\partial y} = \frac{P ( y + Δ y ) - P ( y - Δ y )}{2 Δ y} \qquad ( 5 )$$

2. Modified Duration=Val01/DirtyPrice (6)

3. Convexity:

$$\begin{matrix}\frac{{\partial }^{2} P}{\partial {y}^{2}} = \frac{P ( y + Δ y ) - 2 P ( y ) + P ( y - Δ y )}{{( Δ y )}^{2}} & ( 7 ) \\ convexity = \frac{{\partial }^{2} P}{\partial {Y}^{2}} / Dirty Price & ( 8 )\end{matrix}$$

Note convexity here is calculated by a non-linear approximation because of the second order partial derivative.

4. Vega:

P(v=v+Δv)=Price of the bond after 1 point increase in volatility

$$v = \frac{\partial P}{\partial v} = \frac{P ( v = v + Δ v ) - P ( v )}{Δ v} \qquad ( 9 )$$

OAS Configuration. In Database Server 100, for each given RAPTr NT Shared Book 102 that requires OAS computation, there is one OAS Lattice Engine 106. The OAS Lattice Engine 106 is just another PC Trader Workstation 200 with the same RAPTr NT client software installed. All other Trader Workstations 200 accessing Shared Book 102 will use the results from the OAS Lattice Engine 106 to update the prices by linear approximation. Therefore, the calculation on all other Trader Workstations 200 is always in real time, because it always uses the linear approximation method mentioned above. The lattice computation on the OAS Lattice Engine 106 can be shutdown or restarted from any Trader Workstation 200.

OAS Computation Triggers. In the RAPTr NT system, changing any of the following five parameters may trigger OAS computation: (1) Price, (2) Volatility, (3) Spread, (4) Yield Curve and, (5) the manual trigger. However, the action taken on OAS Lattice Engine 106 and on Trader Workstation 200 may be different for some of these triggers:

(1) Changing the price will trigger a full lattice computation for the implied spread and Sensitivity Object factors 104.

(2) Changing either the spread or the volatility will trigger a full lattice computation for the price and the Sensitivity Object factors 104.

(3) If the quotes in the yield curve are changed, the behavior will be different on the server and workstation:

(a) On OAS Lattice Engine 106, there is a timestamp and a numerical trigger threshold for each bond to be priced. If the average change in the yield of instruments in the yield curve is above this threshold, a new OAS computation will be triggered. Once OAS computation is finished, it puts a timestamp on the bond and reset the trigger threshold. This threshold then linearly decays to 0 in a preset time period after the timestamp.

(b) On Trader Workstation 200, any change in the yield curve will trigger an update of the price, Val0, Duration and Convexity. Since this is done by linear approximation, it can be done in real-time.

(4) Manual trigger is used to shutdown or restart computations on OAS Lattice Engine 106 only. The restart will trigger a full OAS lattice computation for all instruments in Shared Book 102, regardless whether any parameters have changed since last OAS computation. This manual trigger appears on all Trader Workstations 200 as a combo-box on the toolbar, therefore any user can shutdown/restart OAS Lattice Engine 106.

Setting Up OAS Matrix Pricing.

(1) For each Shared Book 102, select a computer to host OAS Lattice Engine 106 by putting the OAS Engine key into the Window Registry of that computer which may be a server or workstation (under the subtree: HKEY_LOCAL_MACHINE/SOFTWARE/Kestrel Technologies/RAPTr NT).

(2) Open Shared Book 102 on OAS Lattice Engine 106 and on other client Trader Workstations 200.

(3) Construct a yield curve (if it is not there already) using a computer based tool, such as RAPTrNT's TermStructPad.

(4) Include the column attributes: Benchmark Curve, Benchmark Field, Benchmark Spread and Benchmark Volatility in the AnalysisPad.

(5) Switch on OAS Lattice Engine 106 by Engine Switch 108.

(6) For each dependent instrument in an OAS relationship, enter the Name (description) in the Benchmark Curve field.

(7) Enter the spread, if known, in the Benchmark Spread field.

(8) Enter the volatility in the Benchmark Volatility field. Currently, the volatility defaults to 14 if not entered manually.

Calibrating to a Given Model. The Volatility parameter can be used for calibrating to OAS models from other systems. First take a snapshot of the following parameters from the other system:

(1) Yield Curve (the set of benchmark instrument and their yields)

(2) The bond price

(3) The OAS Then on the RAPTr NT System:

(1) Adjust the yield curve of Shared Book 102 to match the given yield curve

(2) Open the OAS Calculator, enter the given price and OAS and compute the implied volatility.

(3) Enter it the implied volatility in the AnalysisPad.

Assuming volatility is a relatively stable parameter, the calibration does not have to be done frequently.

End of Day Marking to Market. Shutdown and restart OAS Lattice Engine 106.

The present invention has its own independent value apart from its use to analyze coupon-bearing bonds with embedded options. Other instruments and applications in financial industry can also be adaptable to the present invention. For instance:

(1) Mortgage Pools: The problem of computational resource stated in the beginning of this document will become more acute in the case of analyzing mortgage instrument. The computing time for each pool could be more than ten folds of a regular callable bond. Therefore user would benefit more from the dual architecture proposed above. On the other hand, mortgage instrument can be highly non-linear, we may need in this case a higher degree approximation then that of the linear approximation

(2) Interest-rate derivatives: Once again, the present invention can used to analyze a whole range of derivative products, from plain vanilla one to highly exotic ones.

(3) Risk Management. The Sensitivity Object factor 104

$$( \frac{\partial P}{\partial {Y}_{1}} , \frac{\partial P}{\partial {Y}_{2}} , \frac{\partial P}{\partial {Y}_{3}} , … , \frac{\partial P}{\partial {Y}_{n}} )$$

is also an important risk factor. The entries of this vector represent the bond's risk exposure measured in terms of instruments in the yield curve. These vectors can be utilized for risk-management, portfolio hedging and portfolio optimization. In fact this is precisely what many existing risk management systems have done. The difference is that we realized that the vector could also be used as the coefficients for 1^{st} order approximation of the bond prices.

(4) Generic Analytic Engine. It is very natural in a client server environment that user interface functions and other computationally intensive tasks are done on separate machines. The linear approximation method is an approach to isolate the computationally intensive tasks. Given any analytic library for any type of security, the same architecture can be applied to wrap the library into a RAPTr NT matrix-pricing engine for the security. Since the architecture is model neutral, it is a powerful tool for integrating and enhancing third party analytic libraries, and thus provides flexibilities to the RAPTr NT system.

The present invention may be easily practiced by a user. In the described embodiment above, a user needs only to, on a given RAPTr NT Shared Book 102, utilize OAS Lattice Engine 106 which is just another Trader Workstation 200 with the same RAPTr NT client software installed. All other Trader Workstations 200 accessing Shared Book 102 will use the results from OAS Lattice Engine 102 to update the prices in real time because each Trader Workstation 200 uses the linear approximation method. In addition, the lattice computation on OAS Lattice Engine 106 can be shutdown or restarted from any Trader Workstation 200.

Although the embodiment described according to the invention has utilized a linear approximation, namely, first order partial derivatives, for calculation purposes, it is clear that any other higher order partial derivatives, namely, non-linear approximations are also suitable.

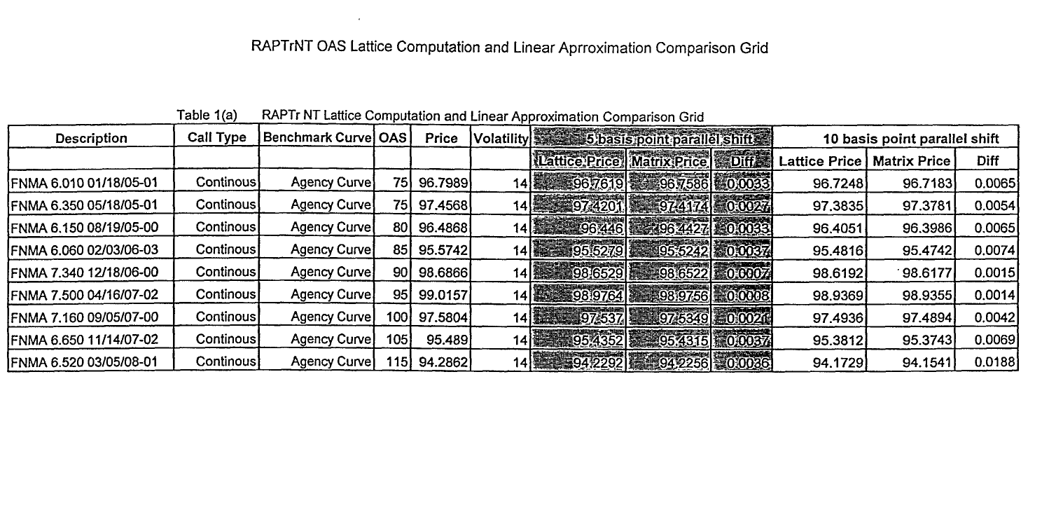

The advantage of the present invention can therefore be seen, which not only enables the user a simple way of calculating OAS thus predicting the price of option-embedded coupon bearing bonds, but also can provide these results in real time. In addition, as shown in FIGS. 2(a) and (b), the accuracy of the linear approximation is very high, the differences between the actual and linearly approximated prices are very small (for most part less than 1 cent) for both 5-point basis or 10-point basis. Further advantage of the present invention is that it enables real time calculation for a plurality of hundreds, or even thousands of bond prices be calculated in real time.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A method of calculating valuations of callable securities for traders, said method comprising the steps of:
a. calculating a benchmark yield curve with a plurality of sensitivity factors and a plurality of linear approximation values to approximate changes of the yield curve in response to changes in one of the sensitivity factors;
b. providing the plurality of linear approximation values to the traders; and
c. monitoring changes in the sensitivity factors and re-calculating the benchmark yield curve and plurality of linear approximations to provide an updated plurality of linear approximations to the traders when the changes in the sensitivity factors indicate a shift in the yield curve which exceeds a predetermined threshold.

2. The method of claim 1 wherein said calculating step includes:
a. forming a current benchmark yield curve vector Y=(Y₁, Y₂, . . . , Yₙ);
b. calculating a numerical security price P(Y) by solving a partial differential equation of said benchmark yield curve vector Y; and
c. calculating a vector of sensitivities ∂P/∂Y using said security price P(Y) and said benchmark yield curve vector Y.

3. The method of claim 1 wherein said proving step includes:
a. forming a benchmark yield curve vector at time of computation Y⁰=(Y₁⁰, Y₂⁰, . . . , Yₙ⁰);
b. calculating a security price at said time of computation P(Y⁰);
c. creating a benchmark yield curve change vector ΔYᵢ; and
d. linearly approximating said security price P(Y) upon any change in said bond or change in said vector of sensitivities ∂P/∂Y.

4. The method of claim 3 wherein the step of creating said benchmark yield curve change vector ΔYᵢ further comprises the step of calculating ΔY₁=Y₁−Y₁⁰ for i=1 to n.

5. The method of claim 2 wherein the step of calculating said vector of sensitivities ∂P/∂Y further comprises the step of taking first order partial derivatives of ∂P/∂Y for i=1 to n to form
$$\frac{\partial P}{\partial Y} = ( \frac{\partial P}{\partial {Y}_{1}} , \frac{\partial P}{\partial {Y}_{2}} , \frac{\partial P}{\partial {Y}_{3}} , … , \frac{\partial P}{\partial {Y}_{n}} ) .$$

6. The method of claim 2 wherein the step of linearly approximating said bond price P(Y) further comprises the step of utilizing the vector of sensitivities ∂P/∂Y.

7. The method of claim 6 wherein the step of utilizing the vector of sensitivities ∂P/∂Y further comprises the step of adding said bond price at the time of computation P(Y⁰) to the sum of (∂P/∂Yᵢ) ΔYᵢ for i=1 to n.

8. The method of claim 1 wherein said monitoring step includes observing at least changes in one of the following: price, benchmark yield curve, spread, volatility and manual trigger signal.

9. The method of claim 9, further comprising the step of calculating, in real time, risk parameters Val01 and modified duration, by linear approximation and utilizing a benchmark yield curve and dirty price, said risk parameter calculating step comprising the steps of:
a. calculating a double price difference ∂P between an upward parallel shift and an adjacent downward parallel shift of current yield curve;
c. calculating a sum ∂y of said upward and said adjacent downward parallel shifts of said current yield curve;
d. calculating risk parameter Val01 by taking first order partial derivative ∂P/∂y; and
e. calculating the modified duration by dividing Val01 by the dirty price.

10. The method of claim 1 wherein said calculating step uses parameters with said sensitivity factors to approximate changes of the yield curve.

11. The method of claim 10 wherein said step of calculating the double price difference ∂P further comprises the step of calculating ∂P=P(y+Δy)−P(y−Δy).

12. The method of claim 10 wherein said step of calculating said sum ∂y further comprises the step of calculating ∂y=2Δy.

13. The method of claim 10 wherein said step of taking said first order partial derivative further comprises the step of dividing (P(y+Δy)−P(y−Δy)) by 2Δy.

14. The method of claim 9 further comprising the step of calculating, in real time, risk parameter convexity, by non-linear approximation and utilizing a benchmark yield curve, and dirty price, said risk parameter calculating step comprising the steps of:
a. taking a second order partial derivative of bond price P(y) against the benchmark yield curve to calculate a second order partial derivative ∂²P/∂y²; and
b. dividing the second order partial derivative ∂²P/∂y² by said dirty price.

15. The method of claim 14 wherein the step of taking said second order partial derivative ∂²P/∂y²further comprises the steps of:
a. calculating a sum price between an upward parallel shift and an adjacent downward parallel shift of the current yield curve to form (P(y+Δy)+P(y−Δy));
b. subtracting 2P(y) from the sum price to form P(y+Δy)−2P(y)+P(y−Δy);
c. calculating a multiplication ΔyΔy of parallel shifts of the current yield curve; and
d. calculating the convexity by dividing (P(y+Δy)−2P(y)+P(y−Δy)) by ΔyΔy to form (P(y+Δy)−2P(y)+P(y−Δy))/(Δy)².

16. A method of claim 9 further comprising the step of calculating, in real time, a risk parameter Vega, by linear approximation and utilizing volatility curve, said risk parameter calculating step comprising the step of:
a. taking a first order partial derivative of a bond price over the volatility curve.

17. The method of claim 16 wherein the step of taking said first order partial derivative further comprises the steps of:
a. calculating a volatility difference Δv between 1 point increase in volatility;
b. calculating a bond price difference after 1 point increase in volatility to form a bond difference P(v=v+Δv)−P(v); and
c. dividing the bond difference P(v=v+Δv)−P(v) by the volatility difference Δv.

18. A system for calculating valuation in real time for callable securities, said system adapted to be connected to a plurality of workstations used by securities traders, said system comprising:
a. a server having a processor and storage, said storage being adapted to be accessed by the workstations;
b. a shared book object on said server, said shared book including a yield curve and a plurality of linear approximation factors for use by the workstations to calculate valuations of callable securities in response to changes in market conditions; and
c. a lattice engine program accessible by one of said server and the workstations, said lattice engine enabling one of said server and the workstations to calculate a new yield curve and plurality of linear approximation values and store the calculated yield curve and plurality of linear approximations on said shared book.

19. The system of claim 18 wherein said lattice engine program was at least one of changes of price, volatility, spread, yield curve and a manual trigger signal to initiate calculation of the new yield curve.

20. The system of claim 18 wherein said shared book includes security prices derived from external sources, and said lattice engine program calculates other prices of other securities through predefined relations.

21. The system of claim 18 wherein said lattice engine program time-stamps the bond price, yield curve and predetermined threshold, and initiates a full lattice computation if average change in said yield curve is above said predetermined threshold, and time-stamps the bond price, yield curve and predetermined threshold after the full lattice computation, with the predetermined threshold decaying to zero in a predetermined time period after the time stamping.

22. The system of claim 18 further comprising triggering means for monitoring changes in the yield curve and activating said lattice engine program if changes in the yield curve exceed a predetermined threshold.

23. The machine-readable program storage device of claim 21 wherein the step of forming said benchmark yield curve change vector ΔYᵢ further comprises the steps of calculating ΔY₁=Y₁−Y₁⁰ for i=1 to n.

24. The machine-readable program storage device of claim 21 wherein the step of forming said numerical bond price P(Y) further comprises the step of paring individual bond prices P(Yᵢ) with said Yᵢ for i=1 to n.

25. The machine-readable program storage device of claim 21 wherein the step of forming said vector of sensitivities ∂P/∂Y further comprises the step of taking first order partial derivatives of ∂P/∂Yᵢ for i=1 to n to form
$$\frac{\partial P}{\partial Y} = ( \frac{\partial P}{\partial {Y}_{1}} , \frac{\partial P}{\partial {Y}_{2}} , \frac{\partial P}{\partial {Y}_{3}} , … , \frac{\partial P}{\partial {Y}_{n}} ) .$$

26. The machine-readable program storage device of claim 21 wherein the step of linearly approximating said bond price P(Y) further comprises the step of utilizing the vector of sensitivities ∂P/∂Y.

27. The machine-readable program storage device of claim 25 wherein the step of utilizing said vector of sensitivities ∂P/∂Y further comprises the step of adding said bond price at the time of computation P(Y⁰) to the sum of (∂P/∂Yᵢ) ΔYᵢ for i=1 to n.

28. The machine-readable program storage device of claim 21 wherein said change in said external bond comprising changes in price, yield curve, spread, volatility and manual trigger signal.

29. A machine-readable program storage device for storing encoded instructions for a method of calculating, in real time, risk parameters Val01 and modified duration, by linear approximation and utilizing an external benchmark yield curve, and dirty price, said method comprising the steps of:
a. calculating a double price difference ∂P between an upward parallel shift and an adjacent downward parallel shift of said external current yield curve;
c. calculating a sum ∂y of said upward and said adjacent downward parallel shifts of said external current yield curve;
d. calculating risk parameter Val01 by taking first order partial derivative ∂P/∂y; and
e. calculating said modified duration by dividing Val01 by the external dirty price.

30. The machine-readable program storage device of claim 28 wherein said step of calculating the double price difference ∂P further comprises the step of calculating ∂P=P(y+Δy)−P(y−Δy).

31. The machine-readable program storage device of claim 28 wherein said step of calculating said sum ∂y further comprises the step of calculating ∂y=2Δy.

32. The machine-readable program storage device of claim 28 wherein said step of taking said first order partial derivative further comprises the step of dividing (P(y+Δy)−P(y−Δy)) by 2Δy.

33. A machine-readable program storage device for storing encoded instructions for a method of calculating, in real time, risk parameter convexity, by non-linear approximation and utilizing an external benchmark yield curve and dirty price, said method comprising the steps of:
a. taking a second order partial derivative of bond price P(y) against the external benchmark yield curve y to calculate a second order partial derivative ∂²P/∂y²; and
b. dividing the second order partial derivative ∂²P/∂y² by the external dirty price.

34. The machine-readable program storage device of claim 32 wherein the step of taking said second order partial derivative ∂²P/∂y² further comprises the steps of:
a. calculating a sum price between an upward parallel shift and an adjacent downward parallel shift of the current yield curve to form (P(y+Δy)+P(y−Δy));
b. subtracting 2P(y) from the sum price to form P(y+Δy)−2P(y)+P(y−Δy);
c. calculating a multiplication ΔyΔy of parallel shifts of the current yield curve; and
d. calculating the Convexity by dividing (P(y+Δy)−2P(y)+P(y−Δy)) by ΔyΔy to form (P(y+Δy)−2P(y)+P(y−Δy))/(Δy)².

35. A machine-readable program storage device for storing encoded instructions for a method of calculating, in real time, a risk parameter Vega, by linear approximation and utilizing external volatility curve, said method comprising the step of:
a. taking a first order partial derivative of a bond price over the external volatility curve.

36. The machine-readable program storage device of claim 34 wherein the step of taking said first order partial derivative further comprises the steps of:
a. calculating a volatility difference Δv between 1 point increase in volatility;
b. calculating a bond price difference after 1 point increase in volatility to form a bond difference P(v=v+Δv)−P(v); and
c. dividing the bond difference P(v=v+Δv)−P(v) by the volatility difference Δv.
